(19) United States
(12) Patent Application Publication
(10) Pub. No.: US 2017/0147690 A1
(43) Pub. Date: May 25, 2017

(54) System And Method For Transmitting and Answering A Query Through A Short Message Service Format

(71) Applicant: Angelo Mastrio, II, Las Vegas, NV (US)

(72) Inventor: Angelo Mastrio, II, Las Vegas, NV (US)

(21) Appl. No.: 14/948,913

(22) Filed: Nov. 23, 2015

(51) Int. Cl. G06F 17/30; G06Q 30/00; H04W 4/14

(52) U.S. Cl. CPC G06F 17/30864; G06F 17/30554; H04W 4/14; G06Q 30/016

(57) ABSTRACT

A system and method enables a querying party to transmit a query and receive an answer through a short message service format, such as text. The system is especially effective for answering queries from a sales representative in the field. The system provides two sources for providing an answer to the query: a data storage portion that stores: data pertinent to the query, prior queries, and personal information of the querying party. A search algorithm analyzes the query and may provide an answer based on the stored data in the data storage portion. If the data storage portion cannot answer the query, the query is pinged to a person for answering. In either case, the answer is returned to the querying party in short message service format. The data storage portion accumulates the query, prior queries, the answer, and general information to provide enhanced analysis for answering subsequent queries.

### FIELD OF THE INVENTION

The present invention relates generally to a system and method for transmitting and answering a query through a short message service format. More so, a system and method enables a querying party to transmit a query through a short message service format to a data storage portion; whereby the data storage portion includes a search algorithm that utilizes data, prior queries, and general information of the querying party to transmit an answer to the query; whereby if the data storage portion cannot answer the query, the data storage portion redirects the query to a person specialized in the field of the query; whereby the person provides the answer to the query; and whereby the query and the answer are accumulated in the data storage portion for helping to answer a subsequent query.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that a web search engines, such as Google™, Bing™, and Yahoo!™, are designed to search for information on the World Wide Web. In many instances, the search results are usually presented in a list and are commonly called hits. The information may consist of web pages, images, documents and other types of files. Some search engines also mine data available in databases or open directories.

Generally, text messaging is the common term for the sending of short text messages of 160 characters or less from mobile phones using the Short Message Service (SMS). Texting is available on most digital mobile phones and some personal digital assistants with on-board wireless telecommunications. The individual messages which are sent are called texts.

Typically, a database includes hardware that consists of a collection of data organized for one or more purposes, typically in digital form. Databases may be classified by the type of their contents, for example: bibliographic, document-text, statistical.

Generally, sales people are often judged upon the amount of product sold to customers. Sales representatives are on commission based upon the amount of product which they sell. This often depends on maintaining a relationship with their customers with a view of increasing future product sales, and providing accurate information to their customer's questions. Often, the accurate answers must be procured in the field, and within seconds.

In many instances, sales people use customer relationship management (CRM) software products specifically designed to assist with managing their relationships with customers, including the capture, storage and analysis of customer information. These software products enable the sales person to access data relating to prospective and existing clients stored within a CRM database.

Other proposals have involved querying CRM database to answer customer questions. The problem with these querying systems is that they require Internet access and a long duration to receive an accurate answer, especially from the field. Even though the above querying systems meets some of the needs of the market, a system and method for transmitting and answering a query through SMS format, and providing an intelligent database and a secondary source of a live person to quickly answer the query is still desired.

### SUMMARY OF THE INVENTION

The present invention is directed to a system and method for transmitting and answering a query through a short message service (SMS) format, such as a text. The system operates essentially as a search engine, except that instead of transmitting a query through the use of standard text or images, the query is transmitted in the SMS format. The SMS format is short and easy to operate. The SMS format is also more efficient for stripping the query to a root context. The root context of a query enables more efficient matching and comparison algorithmic computations. Thus, the generally short, simplistic format of the query provides more efficient query transmission options for a querying party, and also expedites analysis and answering the query.

Further, since the SMS format is operable from a mobile communication device, the querying party can easily transmit the query, and the answer is received almost instantaneously from a data storage portion through analysis by a search algorithm that matches and compares data in the data storage portion. Or if the database cannot answer the query, at least one person, who is specialized in the field of the query answers the query.

The system and method takes into account not only the query, but also general information about the querying party, the timing of the query, at least one prior query, and accumulated data consisting of historical answers. Thus, the system initially collects general information about the querying party in a data storage portion. This general information about the querying party serves not only to enhance the analysis of the query, but also serves as a data mining tool and forms the basis for future marketing data.

The querying party may transmit the query to the data storage portion. Because the query is transmitted through SMS text, the querying party can easily transmit queries from the field through a standard mobile communication device. The data storage portion receives the query for response. The data storage portion may be configured to respond to myriad topics, or a single specialized topic.

The data storage portion may utilize a search algorithm to analyze the query in real time. The search algorithm analyzes the accumulated data and historical queries in the data storage portion to optimize the analysis of the text query. The accumulated historical data, constant feed of new data, the general information of the querying party, and the timing of the query enable the search algorithm to have an enhanced capacity to answer the queries. Thus, the data storage portion serve as a means to share, capture, and store data in the form of questions and answers.

The algorithm analysis the data in the data storage portion to answer the query. The data may be stored individually as records, or may be elements of a search space defined by a mathematical formula or procedure, or a combination of both. In some embodiments, the search algorithm may utilize heuristics to generate an answer to the query. After appropriate analysis, the data storage portion transmits an answer in the form of SMS text back to the querying party. After providing the answer, the search algorithm has additional data for analyzing future queries. Further, the instantaneous text recognition capacities of the algorithm are enhanced.

However, if the data storage portion does not have sufficient data to answer the query, the data storage portion may redirect the query to at least one person. This redirection of the query may be performed through a ping or a traceroute. In one embodiment, Internet Control Message Protocol (ICMP) is used to redirect the query to the person. In any case, an instantaneous transmission of the original query is redirected to a person who may have greater capacity to answer the query.

Upon the person answering the query, the answer is transmitted back to the data storage portion. The data storage portion may then transmit the answer to the querying party, and also store the query and the answer that was provided by the person. Thus, the query and the answer from the person become a part of the accumulated data and historical queries in the data storage portion. The search algorithm may then include these most recent queries and answers with the prior queries and answers for analysis of future queries.

The system and method may also serve as a data mining tool. This is possible because the search algorithm stores and analysis at least one of the following: the query, the source of the query, the timing of the query, and the initially provided general information about the querying party. This data becomes a part of the accumulated data for answering future queries. This data may also be used for future marketing purposes.

In one aspect, a method for transmitting and answering a query in a short message service format, comprises:

providing, by a querying party, general information, the general information generally pertinent to the querying party;

generating, by the querying party, a query; transmitting the query to a data storage portion, the query configured in a short message service format, the data storage portion comprising data for at least partially providing an answer to the query, the data storage portion further comprising at least one prior query;

providing a search algorithm, the search algorithm configured to analyze the query, the search algorithm further configured to generate an answer to the query based at least partially on the data in the data storage portion, the general information of the querying party, and the at least one prior query;

determining if the search algorithm can answer the query, the determination dependent on at least one of the following: the data in the data storage portion, the general information of the querying party, and the at least one prior query;

if the determining is that the search algorithm answers the query, transmitting an answer to the querying party, the answer configured in the short message service format;

if the determining is that the search algorithm fails to answer the query, transmitting the query to at least one person, the at least one person authorized to answer the query;

transmitting the answer, by the at least one person, to the data storage portion;

storing the query and the answer in the data storage portion with the at least one prior query, whereby the query, the answer, and the at least one prior query are configured to help answer a subsequent query; and

transmitting the answer to the querying party, the answer configured in the short message service format.

In another aspect, the querying party is a field sales representative.

In another aspect, the data storage portion is a customer relationship management database.

In another aspect, the method further includes the step of updating the customer relationship management database with the query and the answer for answering the subsequent query.

In another aspect, the short message service format is a text.

In another aspect, the person is at least one preauthorized specialist in a sales field.

In another aspect, the general information includes at least one member selected from the group consisting of: contact information, pricing, sales history, product specifications, product information, competitive information, contracts, internal organizational charts, legal updates, clinical data, press releases, and publications.

In another aspect, the search algorithm is configured to analyze a root context of the query.

In another aspect, the search algorithm further analyzes the timing of the query for storage in the data storage portion with the query, the answer, and the at least one prior query to help answer the subsequent query.

In another aspect, the step of transmitting the query to a person, further includes pinging the query to the person.

In another aspect, the method further includes the step of directing the query to a specialized person.

In another aspect, the specialized person includes at least one member selected from the group consisting of: a legal specialist, a senior sales representative, a sales manager, an engineer, and a clinical specialist.

In another aspect, the method further includes a high level person, the high level person authorized to answer a specialized query.

In another aspect, the high level person includes at least one member selected from the group consisting of: a chief operating officer, a director, a vice president, a research and development researcher, and a regulatory specialist.

In another aspect, the method further includes the step of directing the query to an administrative person.

In another aspect, the administrative person includes at least one member selected from the group consisting of: an information technology specialist and a data entry clerk.

One objective of the present invention is to enable queries to be transmitted and answered in the field through short message services text formats.

Another objective is to provide a sales representative in the field with a quick, efficient method for answering sales related questions.

Another objective is to provide an intelligent customer relationship management database or platform that can be updated with cumulative queries and corresponding questions for enhancing the answering of subsequent queries.

Another objective is to provide a secondary means of answering the query if the data storage portion cannot answer, in the form of a real person who is specialized in the field of the query.

Another objective is to provide a search algorithm that utilizes comparative logic, heuristics, and other search engine analysis means to provide the answer to the query.

Yet another objective is to provide multiple levels of at least one person to operate the system and method and to answer the query, including a real person, a specialized person, a high level person, and an administrative person.

Yet another objective is to provide an inexpensive to develop and operate system and method for answering technical queries through short message service texts.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram of an exemplary system for transmitting and answering a query in a short message service format, in accordance with an embodiment of the present invention;

FIGS. 2A and 2B illustrate flowchart diagrams of an exemplary method for transmitting and answering a query in a short message service format, in accordance with an embodiment of the present invention;

FIG. 3 illustrates a diagram of an exemplary first embodiment of an information texting system, in accordance with an embodiment of the present invention;

FIG. 4 illustrates a diagram of an exemplary second embodiment of an information texting system, in accordance with an embodiment of the present invention; and

FIG. 5 illustrates a diagram of an exemplary text CPU router, in accordance with an embodiment of the present invention.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments.

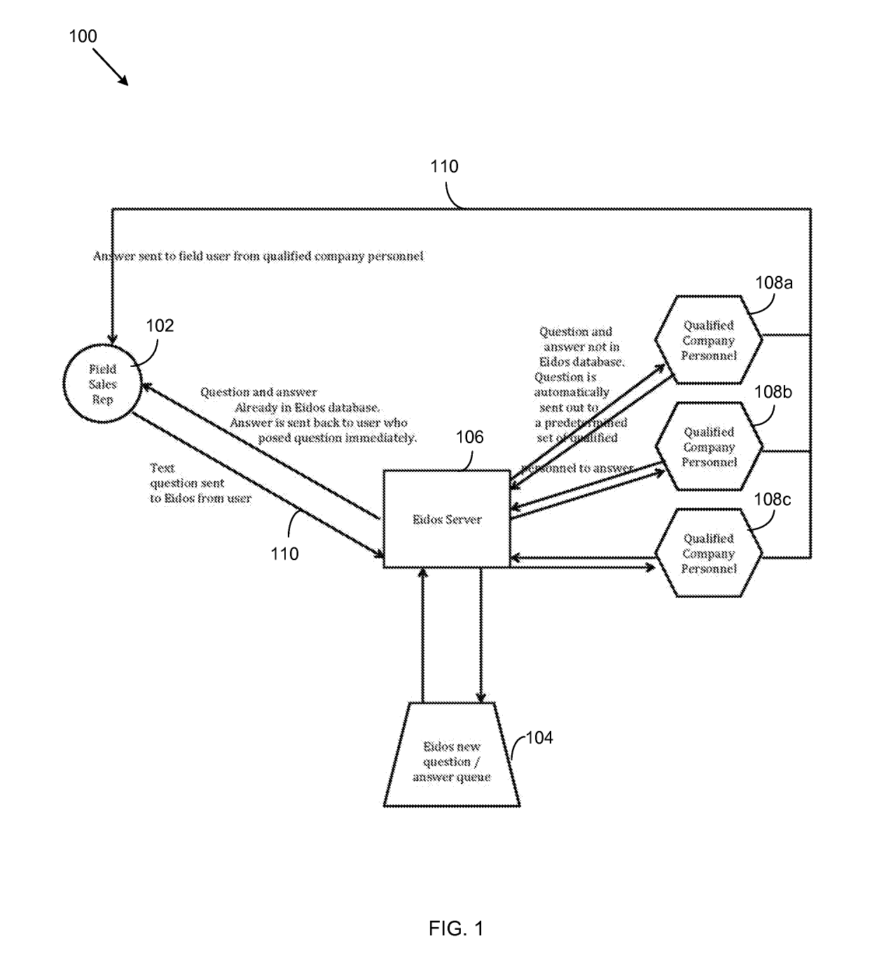

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1-5 references a system 100 and method 200 for transmitting a query 104 and quickly receiving an answer 110 through a short message service (SMS) format. System 100 is especially effective for helping to answer query 104 from a sales representative in the field, since the transmission, analysis, and answering of query 104 are almost instantaneous due to the technical nature of SMS format. System 100 is also effective in that it provides two potential sources for providing answer 110 to query 104.

The first possible source for answering query 104 is a data storage portion 106 that stores data pertinent to query 104. Data storage portion 106 also stores at least one prior query and personal information of the querying party 102 to further enhance the analysis and accuracy of query 104. The second source for answers is at least one person 108a-c, who is specialized in the field of the query 104. Data storage portion 106 redirects query 104 to person 108a-c if the data storage portion 106 cannot answer query 104.

A search algorithm analyzes query 104 from data storage portion 106, and may deduce answer 110 by matching and comparing the query with stored data in data storage portion 106. If the search algorithm cannot answer query 104, then query 104 is pinged to person 108a-c for answering. In either case, answer 110 is returned to querying party 102 in SMS format.

To create optimal answer retrieval, data storage portion 106 accumulates at least one of the following: query 104, at least one prior query, answer 110, and general information about querying party 102. This data is used to provide more accurate answers 110 for a subsequent query that is posed to data storage portion 106. In this manner, data storage portion 106 uses intelligence while constantly accumulating data pertinent to the field of query 104.

As referenced in FIG. 1, querying party 102 may include a sales representative. Though in other embodiments, querying party 102 may include a technician or a specialist who requires answers quickly while in the field. Thus, system 100 utilizes the SMS format for expediting the transmission of the query 104 and the corresponding answer 110. In one embodiment, system 100 operates essentially as a search engine, except that instead of sending a standard query comprised of standard text or images, query 104 is transmitted in the SMS format. In one embodiment, the SMS format includes texts having a predetermined length of characters that can be sent from a mobile communication device.

Those skilled in the art will recognize that the SMS format is short and easy to operate. The SMS format is also more efficient for the search logarithm to strip down to a root context. This generally short, simplistic root context of the query 104 provides more efficient query transmission options for querying party 102, and also expedites analysis and answering the query 104. Further, since the SMS format is operable from a mobile communication device, querying party 102 can easily transmit query 104, and answer 110 is received almost instantaneously from data storage portion 106 or person 108a-c.

For generating answers, system 100 takes into account not only query 104, but also general information about querying party 102, the timing of the query 104, accumulated data consisting of at least one prior query, and historical answers. Thus, system 100 initially collects general information about querying party 102 and populates the general information in data storage portion 106. This general information serves not only to enhance the analysis of the query 104, but also serves as a data mining tool and forms the basis for future marketing data.

The general information of provided by querying party 102 may include, without limitation, customer contact information, pricing, sales history, product specifications, product information, competitive information, contacts, internal organizational charts, legal updates, clinical data, press releases, and publications. In on embodiment, this information is stored and accessed through a secure database having selective and tiered accessibility.

In another example, the timing of the query is stored in data storage portion 106 and analyzed for helping to answer the query 104. The timing of the query may include, without limitation, the time of day, the day of the week, and the season. In yet another example, the at least one prior query is stored and analyzed for answering subsequent query. This enables the search algorithm to match queries and answers or create a comparative analysis based on heuristics and other mathematical search engine type models known in the art.

After providing general information, querying party 102 transmits query 104 to data storage portion 106. Because query 104 is transmitted through SMS text, querying party 102 can easily transmit queries from the field through a standard mobile communication device. Data storage portion 106 receives the query 104 for response. Data storage portion 106 may be configured to respond to myriad topics, or a single specialized topic. In one embodiment, data storage portion 106 is a customer relationship management (CMR) database and platform.

For example, the query may be, “What is the price of xyz at ACME Hospital Group?” It is significant to note that query 104 is short, concise, and to the point, which is consistent with SMS formatting. In one embodiment, query 104 may be stripped to a root context of “price”, “xyz”, and “ACME hospital”. The root context expedites the analysis of the query 104, thereby enabling expedited answering capacity for the system 100.

As discussed above, data storage portion 106 includes a search algorithm that utilizes data, prior queries, and general information of the querying party 102 to transmit answer 110 to querying party 102. The search algorithm analyzes the accumulated data and historical queries in the data storage portion 106 in real time. The search algorithm also strips query 104 down to a root context to expedite comparisons between the data in the data storage portion 106 and the query 104. This creates optimal analysis of the text query. The accumulated historical data, constant feed of new data, the general information of the querying party 102, and the timing of the query 104 enable the search algorithm to have an enhanced capacity to answer 110 the query 104. Thus, data storage portion 106 serve as a means to share, capture, and store data in the form of questions and answers.

The search algorithm is configured to analyze the data in the data storage portion 106 and compare this data against query 104, or more specifically the root context of the query 104, for efficient providing efficient answer to query 104. The data in data storage portion 106 may be stored individually as records, or may be elements of a search space defined by a mathematical formula or procedure, or a combination of both. In some embodiments, the search algorithm may utilize heuristics to generate an answer to the query. After appropriate analysis, data storage portion 106 transmits answer 110 in the form of SMS text back to querying party 102.

After providing answer 110, the search algorithm accesses additional data for analyzing subsequent queries. The accessed data may include the query 104, the answer 110, at least one prior query, and the personal information of the querying party 102. Further, by stripping the query 104 to a root context, the instantaneous text recognition capacities of the search algorithm are enhanced. For example, answer 110 to the above posed query may be, “xyz=$500 at ACME Hospital Group”. It is significant to note that the answer is short, concise, and to the point, which is consistent with SMS formatting.

However, if the data storage portion 106 does not have sufficient data to accurately respond to query 104, then data storage portion 106 may redirect query 104 to at least one person 108a-c who is specialized in the field of the query 104. In this aspect, person 108a-c provides the answer 110 to query 104. In one embodiment, the redirection of the query 104 to person 108a-c may be performed through a ping or a traceroute. In another embodiment, Internet Control Message Protocol (ICMP) is used to redirect query 104 to person 108a-c. In any case, an instantaneous transmission of query 104 is redirected to a specialized person who may have greater capacity than the data storage portion 106 to provide an answer 110.

In one embodiment, person 108a-c may include a specialized technician who has thorough knowledge of the field, and is thus qualified to provide answer 110 quickly and accurately. In one embodiment, person 108a-c may include multiple people who are selected to receive query 104, either randomly, or based on amount of knowledge. The order of selection for person 108a-c may be predetermined and programmed into data storage portion 106.

There are various tiers that person 108a-c can be categorized. The tier determines the type of query 104 that is transmitted to person 108a-c, and the functions of person 108a-c within the system 100. In one aspect, person 108a-c is in a tier of being a specialized person 108a. The specialized person 108a includes at least one member selected from the group consisting of: a legal specialist, a senior sales representative, a sales manager, an engineer, and a clinical specialist.

Another tier involves a high level person 108b. High level person 108b is authorized to answer 110 a very specialized or difficult to interpret query 104. High level person 108b includes at least one member selected from the group consisting of: a chief operating officer, a director, a vice president, a research and development researcher, and a regulatory specialist. Yet another tier includes an administrative person 108c. Administrative person c includes at least one member selected from the group consisting of: an information technology specialist and a data entry clerk.

Upon person 108a-c answering the query, the answer is transmitted back to the data storage portion 106. The data storage portion 106 may then transmit the answer 110 to the querying party 102. The data storage portion 106 may also store both the query 104 and the answer 110 that was provided by person 108a-c. Thus, query 104 and answer 110 from person 108a-c become a part of the accumulated data and historical queries in data storage portion 106. The search algorithm may access and analyze these most recent queries and answers with the prior queries and answers for analysis of subsequent queries.

For example, the original query 104 and all corresponding answers provided by person 108a-c are stored, i.e., archived, in the data storage portion 106. The person 108a-c supplied answers are organized and stored in a queue. Every month, an administrative person 108c, such as a data entry clerk, works with a high level person 108b, such as a manager, to vet all of the queries and answers in the queue and add them to data storage portion 106 for future, automatic recognition.

As an additional benefit of the accumulation of data, system 100 serves the secondary purpose of a back end data entry platform. The capacity to collect, input, and store the data provides a vast, useful reservoir of information that can be used for enhancing subsequent queries, better understanding the needs of customers and industry, and providing marketing information. Thus in one exemplary use, system 100 can be leveraged by a company with outside sales or service person 108a-cnel as a means to share, capture, and store data in the form of questions and answers.

In essence an accumulation of queries and their respective answer are stored in the data storage portion 106 for helping to respond to subsequent query 104 with answer 110. In one alternative embodiment, the search algorithm further analyzes the timing of the query. The timing of the query is stored in the data storage portion 106 with the other data mentioned above, such as at least one prior query, personal information of querying party 102, and historical answers. The timing of the query may include, without limitation, the time of day, the day of the week, and the season. This information is stored in data storage portion 106 for analysis by the search algorithm and to help answer subsequent queries more efficiently and accurately. Thus, query 104, answer 110, at least one prior query 104, general information of the querying party 102, and timing of the query 104 are factored in together to help enhance the answering of a subsequent query.

Those skilled in the art, in light of the present teachings, will recognize that system 100 is especially useful to sales representatives working in the field, who may need technical questions answered quickly and accurately. For example, system 100 may help a client's busy field sales representative with a text message based on a Question and Answer platform that doubles on the back end as a data entry platform to constantly and automatically update the client's sales force or other customer relationship management CRM system.

In some embodiments, system 100 may also serve as a data mining tool. This is possible because the search algorithm stores and analysis at least one of the following: the query 104, the source of the query, the timing of the query, and the initially provided general information of the querying party 102. This data becomes a part of the accumulated data for answering subsequent queries. This data may also be used for future marketing endeavors.

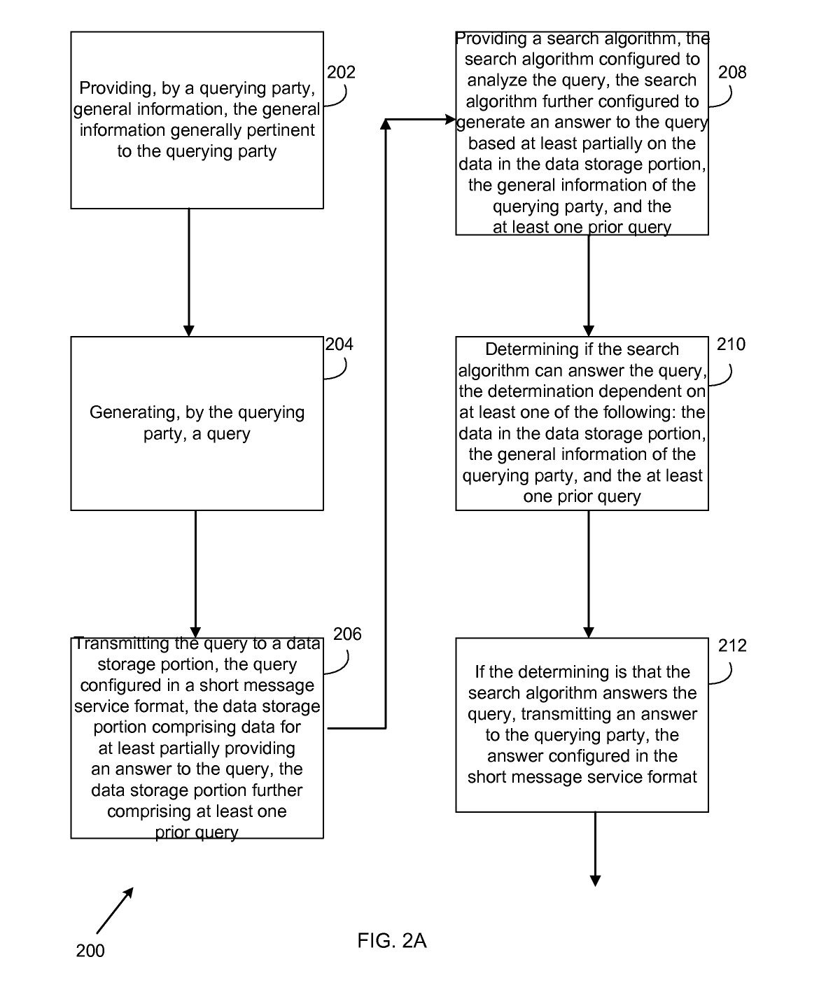

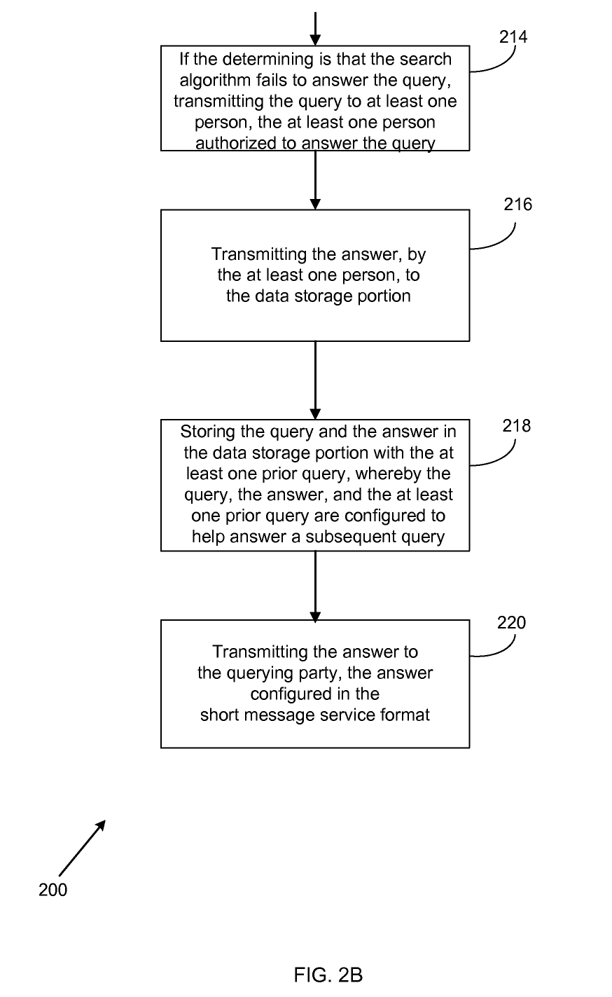

FIGS. 2A and 2B illustrate flowchart diagrams of an exemplary method 200 for transmitting and answering a query 104 in a short message service format. The method 200 may include an initial Step 202 of providing, by a querying party 102, general information, the general information generally pertinent to the querying party 102. The general information helps in answering query 104 that is posed by querying party 102. The general information provides context and historical data for framing query 104. The general information of querying party 102 may include, without limitation, customer contact information, pricing, sales history, product specifications, product information, competitive information, contacts, internal organizational charts, legal updates, clinical data, press releases, and publications.

Method 200 may further comprise a Step 204 of generating, by the querying party 102, a query 104. Querying party 102 may include a sales representative. Though in other embodiments, querying party 102 may include a technician or a specialist who requires answer 110s quickly. Querying party 102 has two potential sources for receiving answer 110. In either case, answer 110 is received at a speed that enables a querying party working in the field to receive an almost instantaneous answer.

A Step 206 includes transmitting the query 104 to a data storage portion 106, the query 104 configured in a short message service format, the data storage portion 106 comprising data for at least partially providing an answer 110 to the query 104, the data storage portion 106 further comprising at least one prior query 104. In this Step 206, query 104 may include a technical question. For example, a field sales representative may ask if a product or service can be discounted if purchased in volume. In one embodiment, query 104 is configured as a text. The text is short and relatively easy to break down to a root context, which expedites analysis of query 104 for answering. Thus, SMS format is configured to expedite the transmission of query 104 and the corresponding answer 110. The SMS format may include texts that can be sent from a mobile communication device.

Those skilled in the art will recognize that the SMS format is short and easy to operate. The SMS format is also more efficient for stripping to a root context. This generally short, simplistic format of query 104 provides more efficient query 104 transmission options for a querying party 102, and also expedites analysis and answering query 104. Further, since the SMS format is operable from a mobile communication device, querying party 102 can easily transmit query 104, and the answer 110 is received almost instantaneously from data storage portion 106 or person 108a-c.

In some embodiments, a Step 208 comprises providing a search algorithm, the search algorithm configured to analyze the query 104, the search algorithm further configured to generate an answer 110 to the query 104 based at least partially on the data in the data storage portion 106, the general information of the querying party 102, and the at least one prior query 104. Data storage portion 106 includes a search algorithm that utilizes data, prior queries, and general information of the querying party 102 to transmit answer 110 to querying party 102. The search algorithm analyzes the accumulated data and historical queries in data storage portion 106 in real time. The search algorithm also strips query 104 down to a root context to expedite comparisons between the query, and the data in data storage portion 106.

A Step 210 includes determining if the search algorithm can answer the query 104, the determination dependent on at least one of the following: the data in the data storage portion 106, the general information of the querying party 102, and the at least one prior query. The search algorithm that utilizes data, prior queries, and general information of querying party 102 to transmit an answer 110 to query 104. The search algorithm analyzes the accumulated data and historical queries in data storage portion 106 in real time. The search algorithm also strips query 104 down to a root context to expedite comparisons between the data in data storage portion 106 and query 104.

In some embodiments, a Step 212 requires that, if the determining is that the search algorithm answers the query 104, transmitting an answer 110 to the querying party 102, the answer 110 configured in the short message service format. Answer 110 may then be stored in data storage portion 106, becoming a part of the historical answers. Similarly, query 104 is stored as at least one prior query. A Step 214 requires that,

In some embodiments, a Step 214 requires that, if the determining is that the search algorithm fails to answer the query 104, transmitting the query 104 to at least one person 108a-c, the at least one person 108a-c authorized to answer the query. In this embodiment, answer 110 may be redirected as a ping. Thus, an instantaneous transmission of query 104 is redirected to at least one person who may have greater capacity than data storage portion 106 to provide answer 110.

There are various numbers of people 108a-c that can receive the query 104, depending on their knowledge capacity and function in the method 200. In one aspect, person 108a-c is in a tier of being a specialized person 108a. Specialized person 108a includes at least one member selected from the group consisting of: a legal specialist, a senior sales representative, a sales manager, an engineer, and a clinical specialist.

Another tier involves a high level person 108b. High level person 108b is authorized to answer 110 a very specialized or difficult to interpret query 104. High level person 108a-c includes at least one member selected from the group consisting of: a chief operating officer, a director, a vice president, a research and development researcher, and a regulatory specialist. Yet another tier includes an administrative person 108c. Administrative person 108c includes at least one member selected from the group consisting of: an information technology specialist and a data entry clerk.

In some embodiments, a Step 216 may include transmitting the answer 110 to the data storage portion 106. After person 108a-c answers the query 104, the answer 110 is transmitted to data storage portion 106, where it is stored for analysis and answering a subsequent query. A Step 218 comprises storing the query 104 and the answer 110 in the data storage portion 106 with the at least one prior query, whereby the query, the answer, and the at least one prior query are configured to help answer a subsequent query. In one embodiment, answer 110 is also stored in data storage portion 106 and becomes a part of the historical answers. Similarly, query 104 is archived as at least one prior query for future analysis.

In one possible embodiment, the original query 104 and all corresponding answers provided by person 108a-c are stored, i.e., archived, in data storage portion 106. These person supplied answers are organized and stored in a queue. Every month, administrative person 108c, such as a data entry clerk, works with high level person 108b, such as a manager, to vet all of the queries and answers in the queue and add them to data storage portion 106 for future, automatic recognition. A final Step 220 includes transmitting the answer 110 to the querying party 102, the answer 110 configured in the short message service format. Querying party 102 may then proceed with the operation, knowing answer 110 is accurate.

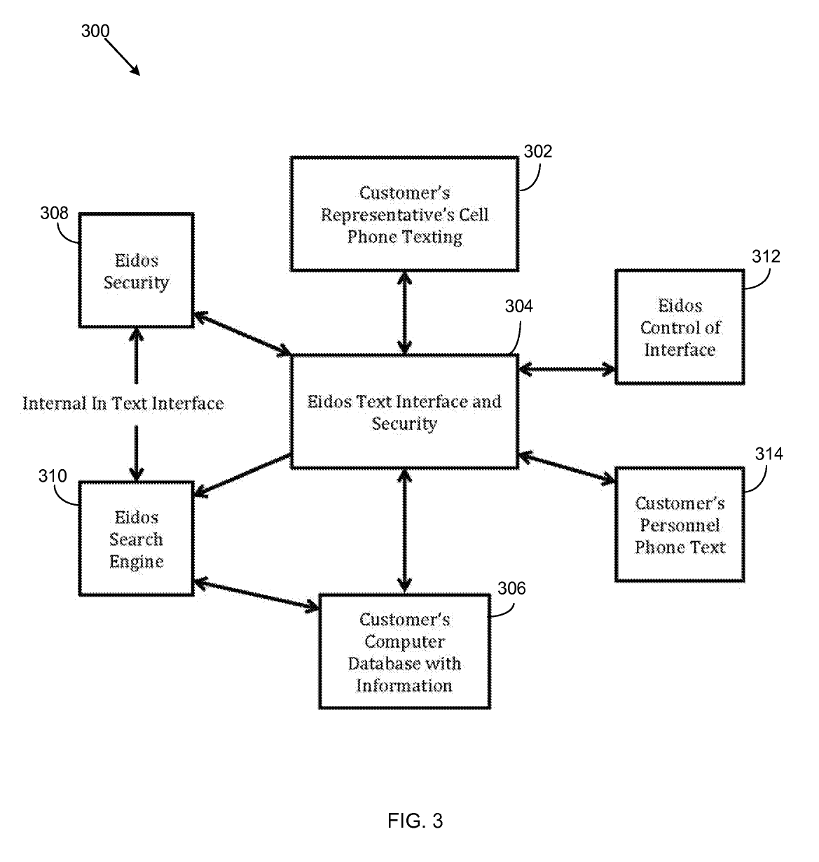

FIG. 3 illustrates a diagram of an exemplary first embodiment of an information texting system 300 for use by a company. In one aspect, the texting system 300 utilizes SMS format in the form of a text to relay the query and answer. The texts are configured to utilize both dedicated company equipment, and non-company equipment generally reserved for the public. The querying party utilizes a mobile communication device 302 to initiate the query and receive the final answer to the query. A text interface 304 provides security and helps traffic the various texts to the appropriate channel. A company database 306 interfaces with the text interface 304. The company database 306 stores data and at least one prior query to help answer the query.

In some embodiments, a security portion 308 and a search engine 310 remain in communication. The security portion 308 communicates with the company database 306 to protect the stored data. The search engine 310 contains a search algorithm that helps analyze the query. In other embodiments, an interface controller 312 allows the various components to be controlled and directed appropriately. A personal communication device 314 initiates and receives texts in the form of query and answer.

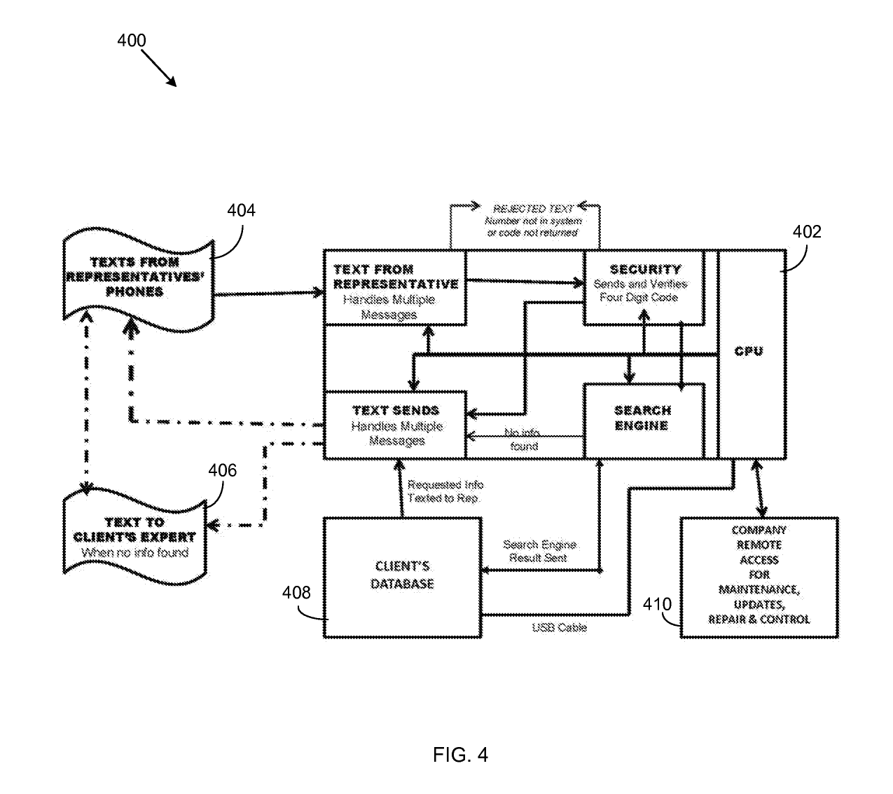

FIG. 4 illustrates a diagram of an exemplary second embodiment of an information texting system 400. In one aspect, the texting system 400 enables information to be transmitted through SMS. The system 400 may include a processing portion 402 that analyzes the query and helps direct the text to the appropriate channel. The processing portion includes a security aspect, a search engine aspect, and text sending hardware. In one embodiment, incomplete texts, are rejected form the texting system 400.

In some embodiments, a representative text 404 is received from the querying party for transmission to the processing portion 402. A client database 408 initially receives the text and may provide an answer. An expert text 406 from a person, who is specialized in the field of the query, may answer the query if the client database 408 could not answer adequately. A remote access portion 410 is operable for remote access, maintenance, updates, repairs, and control to the text system 400.

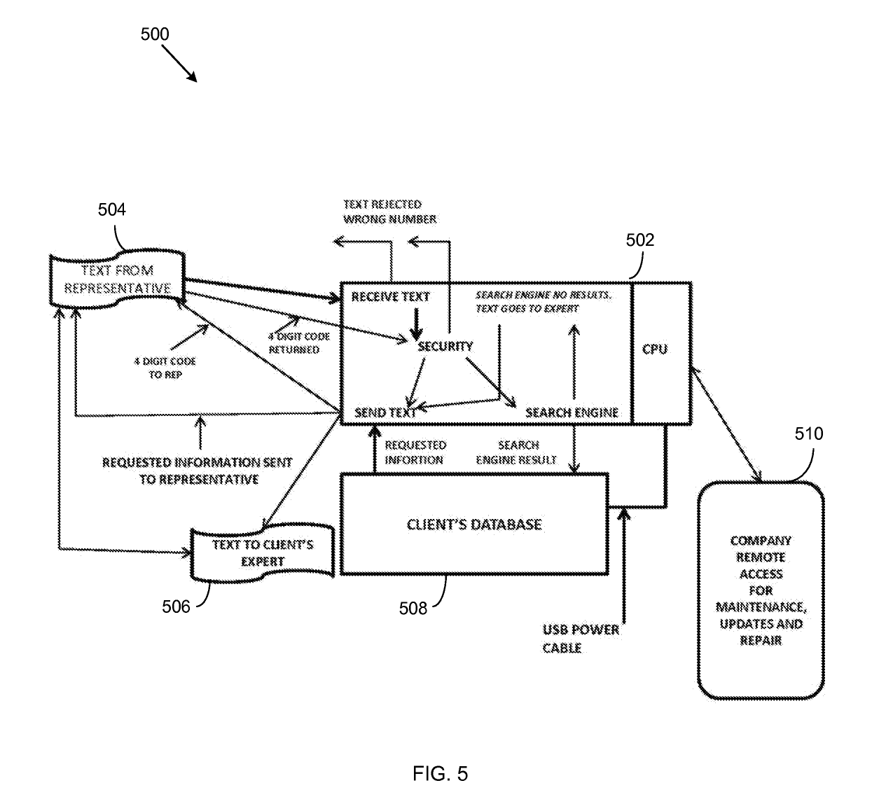

FIG. 5 illustrates a diagram of an exemplary text CPU router system 500. In one aspect, the text CPU router system 500 may include a networking device that forwards the texts between computer networks. The system 500 directs the texts to the appropriate channel and processing component. A search engine 502 works to analyze and retrieve the query from a client database 508. In some embodiments, a representative text 504 is received from the querying party for transmission to a client database 508. The client database 508 initially receives the text and may provide an answer. An expert text 506 from a person, who is specialized in the field of the query, may answer the query if the client database 508 could not answer adequately. A remote access portion 510 is operable for remote access, maintenance, updates, repairs, and control to the text system 500.

These and other advantages of the invention will be further understood and appreciated by those skilled in the art by reference to the following written specification, claims and appended drawings.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A non-transitory computer readable storage medium having computer-executable instructions stored thereon which, when executed by a computer, will cause the computer to:
provide, by a querying party, general information, the general information generally pertinent to the querying party;
generate, by the querying party, a query;
transmit the query to a data storage portion, the query configured in a short message service format, the data storage portion comprising data for at least partially providing an answer to the query, the data storage portion further comprising at least one prior query;
provide a search algorithm, the search algorithm configured to analyze the query, the search algorithm further configured to generate an answer to the query based at least partially on the data in the data storage portion, the general information of the querying party, and the at least one prior query;
determine if the search algorithm can answer the query, the determination dependent on at least one of the following: the data in the data storage portion, the general information of the querying party, and the at least one prior query;
if the determining is that the search algorithm answers the query, transmit an answer to the querying party, the answer configured in the short message service format;
if the determining is that the search algorithm fails to answer the query, transmit the query to at least one person, the at least one person authorized to answer the query;
transmit the answer, by the at least one person, to the data storage portion;
store the query and the answer in the data storage portion with the at least one prior query, whereby the query, the answer, and the at least one prior query are configured to help answer a subsequent query; and
transmit the answer to the querying party, the answer configured in the short message service format.

2. The non-transitory computer readable storage medium of claim 1, wherein the querying party is a field sales representative.

3. The non-transitory computer readable storage medium of claim 1, wherein the data storage portion is a customer relationship management database.

4. The non-transitory computer readable storage medium of claim 1, wherein the method further includes the step of updating the customer relationship management database with the query and the answer in order to respond to the subsequent query.

5. The non-transitory computer readable storage medium of claim 1, wherein the short message service format is a text.

6. The non-transitory computer readable storage medium of claim 1, wherein the general information includes at least one member selected from the group consisting of: contact information, pricing, sales history, product specifications, product information, competitive information, contracts, internal organizational charts, legal updates, clinical data, press releases, and publications.

7. The non-transitory computer readable storage medium of claim 1, wherein the search algorithm is configured to analyze a root context of the query.

8. The non-transitory computer readable storage medium of claim 1, wherein the search algorithm further analyzes at least one of the following for answering the subsequent query: the query, the answer, the timing of the query the data in the data storage portion, and the at least one prior query.

9. The non-transitory computer readable storage medium of claim 1, wherein the step of transmitting the query to at least one person, further includes pinging the query to the at least one person.

10. The non-transitory computer readable storage medium of claim 1, wherein the at least one person is specialized in the field of the query.

11. The non-transitory computer readable storage medium of claim 1, wherein the at least one person is at least one preauthorized specialist in a sales field.

12. The non-transitory computer readable storage medium of claim 1, wherein the method further includes the step of directing the query to a specialized person.

13. The non-transitory computer readable storage medium of claim 12, wherein the specialized person includes at least one member selected from the group consisting of: a legal specialist, a senior sales representative, a sales manager, an engineer, and a clinical specialist.

14. The non-transitory computer readable storage medium of claim 1, wherein the method further includes a high level person, the high level person authorized to answer a specialized query.

15. The non-transitory computer readable storage medium of claim 14, wherein the high level person includes at least one member selected from the group consisting of: a chief operating officer, a director, a vice president, a research and development researcher, and a regulatory specialist.

16. The non-transitory computer readable storage medium of claim 1, wherein the method further includes the step of directing the query to an administrative person.

17. The non-transitory computer readable storage medium of claim 16, wherein the administrative person includes at least one member selected from the group consisting of: an information technology specialist and a data entry clerk.

18. A method for transmitting and answering a query in a short message service format, the method comprising:
providing, by a querying party, general information, the general information generally pertinent to the querying party;
generating, by the querying party, a query;
transmitting the query to a data storage portion, the query configured in a short message service format, the data storage portion comprising data for at least partially providing an answer to the query, the data storage portion further comprising at least one prior query;
providing a search algorithm, the search algorithm configured to analyze the query, the search algorithm further configured to generate an answer to the query based at least partially on the data in the data storage portion, the general information of the querying party, and the at least one prior query;
determining if the search algorithm can answer the query, the determination dependent on at least one of the following: the data in the data storage portion, the general information of the querying party, and the at least one prior query;
if the determining is that the search algorithm answers the query, transmitting an answer to the querying party, the answer configured in the short message service format;
if the determining is that the search algorithm fails to answer the query, transmitting the query to at least one person, the at least one person authorized to answer the query;
transmitting the answer, by the at least one person, to the data storage portion;
storing the query and the answer in the data storage portion with the at least one prior query, whereby the query, the answer, and the at least one prior query are configured to help answer a subsequent query; and
transmitting the answer to the querying party, the answer configured in the short message service format.

19. A system for transmitting and answering a query in a short message service format, the method comprising:
a querying party, the querying party configured to provide general information, the querying party further configured to transmit a query, the query configured in a short message service format;
a data storage portion, the data storage portion comprising data for at least partially providing an answer to the query, the data storage portion further comprising at least one prior query;
a search algorithm, the search algorithm configured to analyze the query, the search algorithm further configured to generate an answer to the query based at least partially on the data in the data storage portion, the general information of the querying party, and the at least one prior query; and
at least one person, the at least one person authorized to provide the answer to the query if the search algorithm fails to answer the query.

20. The system of claim 19, wherein the short message service format is a text.
